(19) United States
(12) Patent Application Publication
(10) Pub. No.: US 2016/0075935 A1
(43) Pub. Date: Mar. 17, 2016

(54) ELECTROLYTE-CONTAINING AQUEOUS POLYMER SOLUTION AND METHOD FOR TERTIARY RECOVERY OF PETROLEUM

(71) Applicant: TOUGAS OILFIELD SOLUTIONS GMBH, Frankfrurt am Main (DE)

(72) Inventors: Carolin Usener, Dülmen (DE); Manfred Krattenmacher, Karben (DE); Fatima Dugonjic-Bilic, Offenbach (DE); Marita Neuber, Dreieich (DE)

(73) Assignee: TOUGAS OILFIELD SOLUTIONS GMBH, Frankfurt am Main (DE)

(21) Appl. No.: 14/784,732

(22) PCT Filed: May 2, 2014
(86) PCT No.: PCT/EP2014/001171

§ 371 Date: Oct. 15, 2015

(30) Foreign Application Priority Data
May 3, 2013 (DE) 10 2013 007 680.3

(51) Int. Cl. C09K 8/588; E21B 43/16

(52) U.S. Cl. CPC C09K 8/588; E21B 43/16

(57) ABSTRACT

An electrolyte-containing aqueous polymer solution is described with a salt content of 5% to 35% by weight with respect to the total weight of the polymer solution, containing at least one dissolved synthetic copolymer which contains structural units which are derived from (i) at least one amide of an ethylenically unsaturated carbonic acid and from (ii) at least one ethylenically unsaturated sulphonic acid or their alkali metal salts and/or ammonium salts, and containing at least one non-ionic surfactant selected from the group formed by alkoxylated fatty alcohols, alkoxylated alkylphenols and/or alkoxylated fatty acids, with the proviso that the mean degree of alkoxylation of said surfactants is 8-10.

The aqueous polymer solution is used for the tertiary recovery of crude petroleum and is characterized by very good filtration behaviour, in particular in the presence of saline water.

The present invention relates to an electrolyte-containing aqueous polymer solution, and its use in the tertiary recovery of crude petroleum.

The fact that only a small fraction of the crude petroleum can be obtained from crude petroleum reservoirs using primary recovery methods has been known for many years. Tertiary recovery methods such as flooding with water, deliver more crude oil. However, a large fraction of the available crude petroleum still remains in the reservoir. Tertiary recovery methods (enhanced crude petroleum recovery (EOR)) are known for being able to increase the yield from reservoirs significantly. One of such EOR methods is the method known as polymer flooding. In that method, aqueous polymer solutions are used, sometimes in combination with a surfactant, in order to have a positive influence on crude petroleum extraction from the reservoir.

Increasing the viscosity of the water by adding polymers changes the mobility ratio of water to crude oil in such a manner that more crude petroleum can be mobilized. High molecular weight partially hydrolysed polyacrylamides are usually used for this purpose. However, the mobility and sweep efficiency can only be successfully controlled when the viscosity of the polymer solution can be maintained throughout the time it is dispersed in the reservoir.

The use of surfactants for EOR methods has already been widely described (see, for example, Surfactants: Fundamentals and Application in the Petroleum Industry, L. L. Schramm, Cambridge University Press, 2000, 203-250. The aim therein is to reduce the surface tension between the water and crude petroleum (crude oil) to obtain emulsification of the crude petroleum in the aqueous phase. Typically, surfactants of the sulphonate, sulphate or carboxylate type are used. However, a disadvantage of that technique is that the quantity of surfactant which is necessary for efficient emulsification of the crude oil, is very high (1% to 5% of the crude oil, in the reservoir), which makes that method uneconomic. Examples of surfactant flooding in the patent literature can be found in DE-AS 1 082 208, DE 34 22 613 A1, DE-AS 26 46 507 and DE-AS 1 234 646.

In order to overcome the disadvantages of surfactant flooding, the method known as alkali-surfactant polymer flooding (ASP) was developed. In this, alkali hydroxides or carbonates are added in combination with polyacrylamides. The surfactant concentration can then be reduced compared with pure surfactant flooding. However, one disadvantage of this method is that the injection water has to be cleaned, as bivalent ions can lead to precipitates with the alkali components. Thus, the injection water has to be freed from such bivalent ions before the ASP method is carried out in order to avoid blockages in the reservoir. This means that this method suffers from both technical and economic limitations.

Many surfactants exhibit cloudiness (cloud point) when introduced into hot salty aqueous solutions. This means that such surfactants agglomerate in hot saline water. Surfaces of this kind are not suitable for surfactant flooding.

Polymer solutions or combinations of surfactant and polymer are now only used in part in order to increase the yield from crude petroleum reservoirs. There are many examples in this regard in the patent literature, such as in DE-AS 1 116 171, DE-AS 1 033 155, DE-AS 1 097 931, DE-AS 1 097 385, DE-AS 1 017 560, DE-AS 1 014 943, DE 25 57 324 A1, DE 25 54 082 A1, DE 14 138 A1, DE-AS 24 32 699, WO 2011/092221 A1, WO 2011/113470 A1 and WO 2010/133258 A1. In many of those documents, the use of cellulose ether derivatives is proposed as the polymer. Such polymers have been shown to be not particularly stable to temperature. In addition, they have only limited resistance to degradation by microorganisms, and so in general they have to be used in combination with biocides.

DE-AS 24 32 699 in particular discloses a method for the production of sedimentation-stable water-in-oil dispersions of acrylamide polymerisates in which the water-in-oil dispersion also contains a wetting agent in addition to a hydrophobic organic dispersion medium, which wetting agent has an HLB of more than 10. Examples which are cited are non-ionic and anionic wetting agents, such as ethoxylated alkylphenols, dialkylesters of sodium sulphosuccinates, soaps of fatty acids containing 10-22 C atoms, as well as alkali salts of alkyl or alkenyl sulphates containing 10-26 C atoms. These emulsifying agents are used as stabilizers in inverse emulsion polymerisation.

US 2010/0197529 A1 describes the use of surfactants together with a polymer which has at least one hydrophobic cationic monomer, in order to emulsify the crude petroleum in the reservoir and thus to increase the recovery. The combination of polymer and surfactant is, however, solely investigated in sodium chloride solutions. Compatibility with bivalent cations is not taught by this document.

WO 00/73623 A1 describes the viscosification of salt solutions by means of hydrophobically associating polymers in combination with at least one surfactant with an overall temperature stability in the range 20° C. to 60° C. The salt content of the solution is 0.5% to 10% by weight with respect to the water.

It is known that in partially hydrolysed polyacrylamides in the presence of bivalent ions such as calcium and magnesium, the viscosity of the polymer falls due to bridge formation between the anionic charges and the Ca or Mg ions (D. B. Levitt, G. A. Pope, SPE 113845, 2008). Finally, this interaction leads to precipitation of the polymer and to total loss of the original viscosity. With increasing temperature, hydrolysis of the acrylamide units increases, which then results in correspondingly faster precipitation of the polymer in the presence of salt. The higher the salt content of the injection solutions, the faster is the loss of viscosity.

Polyacrylamides can be modified with functional monomers such as N-vinylpyrrolidone, N,N-dimethylacrylamide or 2-acrylamido-2-methylpropane sulphonic acid (AMPS). This increases the tolerance towards bivalent cations and protects against hydrolysis due to a stabilizing neighbouring group effect.

DE 10 2004 035 515 A1 describes thermostable, water-soluble polymers which can cross-link at high temperatures. They are derived from various monomers, some of which carry groups which can cross-link with multivalent metal ions. Such copolymers thus form three-dimensional cross-linked networks in the presence of such metal ions and are thus not suitable for surfactant flooding in which non cross-linked copolymers are used.

EP 0 233 533 A2 describes a homopolymer formed from AMPS and a copolymer of AMPS and N, N-dimethylacrylamide. These polymers are described as being thermally stable, even at temperatures of more than 90° C. The quantity of bivalent ions in the test solutions is only a maximum of 1%, however.

Handling and injection of such solutions means that the user is sometimes faced with enormous technical difficulties due to incompatibility of certain additives, especially in highly saline reservoirs.

Thus, a need has arisen for polymer-surfactant combinations which are capable of producing a sufficient viscosity even in highly saline reservoirs, and at the same time of exhibiting appropriate injection behaviour.

Surprisingly, it has been discovered that even in highly saline reservoirs, using a combination of specific water-soluble polymers with specific surfactants, a sufficient viscosity can be produced for polymer flooding in crude petroleum reservoirs, and in that adding the surfactants means that the injectability of the solution into the reservoirs is improved.

The present invention concerns an electrolyte-containing aqueous polymer solution with a salt content of 5% to 35% by weight with respect to the total weight of the polymer solution, containing at least one dissolved synthetic copolymer which contains structural units which are derived from (i) at least one amide of an ethylenically unsaturated carbonic acid and from (ii) at least one ethylenically unsaturated sulphonic acid or their alkali metal salts and/or ammonium salts, and containing at least one non-ionic surfactant selected from the group formed by alkoxylated fatty alcohols, alkoxylated alkylphenols and/or alkoxylated fatty acids, with the proviso that the mean degree of alkoxylation of said surfactants is 8-10.

The term “electrolytes” as used below means organic and inorganic, solid crystalline compounds which dissolve in water with dissociation into cations and anions, wherein water-soluble polymers are excluded from this definition.

The electrolytes in the aqueous polymer solution of the invention are generally present as alkali metal and/or alkaline-earth metal salts. They may be hydroxides, sulphides, sulphites, sulphates, nitrates, phosphates, and preferably halides, in particular chlorides. The salt content of the polymer solution in accordance with the invention is preferably in the range >10% by weight to 35% by weight, preferably in the range 10.5% by weight to 35% by weight, particularly preferably in the range 11% by weight to 35% by weight, particularly preferably in the range 12% by weight to 35% by weight, particularly preferably in the range 13% by weight to 35% by weight, in particular in the range 15% by weight to 25% by weight, with respect to the total quantity of the polymer solution. Particularly preferably, alkali metal salts and/or alkaline-earth metal salts are present as electrolytes, in particular alkali metal halides and/or alkaline-earth metal halides. Within the salt contents cited above, the quantity of salts with multivalent metal ions, in particular from the group formed by alkaline-earth metal ions, is at least 0.01% by weight, preferably at least 1% by weight. Particularly preferably, sodium chloride, potassium chloride, magnesium chloride and/or calcium chloride are present as the electrolytes.

The copolymer used in accordance with the invention is a copolymer which comprises structural units derived at least from carbonic acid amide(s) and from ethylenically unsaturated sulphonic acid(s) as well as, if necessary, further structural units which are derived from monomers which are copolymerisable therewith. Particularly preferably, the copolymer used in accordance with the invention is a copolymer which exclusively comprises structural units which are derived from carbonic acid amide(s) and from ethylenically unsaturated sulphonic acid(s).

Preferably, copolymers are used which comprise structural units which are derived from acrylamide, methacrylamide, their N—C₁-C₄ alkyl derivatives and/or their N-methyloyl derivatives, preferably from acrylamide and/or methacrylamide.

Preferably again, copolymers are used which comprise structural units which are derived from vinylsulphonic acid, 2-acrylamido-2-methyl propanesulphonic acid, 2-methacrylamido-2-methylpropanesulphonic acid, styrenesulphonic acid, their alkali metal salts and/or ammonium salts, preferably 2-acrylamido-2-methylpropanesulphonic acid and/or 2-methacrylamido-2-methylpropanesulphonic acid.

The further monomers which are copolymerisable with carbonic acid amides and with ethylenically unsaturated sulphonic acids are ethylenically unsaturated carbonic acids and/or monomers which are additionally copolymerisable therewith. The latter are in particular selected from the group formed by alkyl esters of ethylenically unsaturated carbonic acids, oxyalkyl esters of ethylenically unsaturated carbonic acids, esters of ethylenically unsaturated carbonic acids with N-dialkylalkanolamines and/or N-vinylamides.

The ethylenically unsaturated carbonic acids are preferably acrylic acid, methacrylic acid, fumaric acid, maleic acid, itaconic acid and/or crotonic acid.

The alkyl ester of ethylenically unsaturated carbonic acids is preferably an alkyl ester of acrylic acid, methacrylic acid, fumaric acid, maleic acid, itaconic acid or crotonic acid, particularly preferably an alkyl ester containing 1-8 C atoms.

The oxyalkyl ester of ethylenically unsaturated carbonic acids is preferably a 2-hydroxyethyl ester of acrylic acid, methacrylic acid, fumaric acid, maleic acid, itaconic acid or crotonic acid.

The ester of ethylenically unsaturated carbonic acids with N-dialkylalkanolamines is preferably N,N-dimethylethanolamine methacrylate, its salt or quaternary products.

The N-vinylamide is preferably N-vinylformamide, N-vinyl acetamide, N-vinyl-N-methylacetamide or cyclic N-vinylamide compounds, preferably N-vinylpyrrolidone, N-vinylcaprolactam or N-vinylpyridine.

Particularly preferably, synthetic water-soluble copolymers are used which consist of structural units which are derived from:
i) at least one amide of an ethylenically unsaturated carbonic acid and at least one ethylenically unsaturated sulphonic acid, as well as their alkali metal salts and/or ammonium salts;
ii) at least one amide of an ethylenically unsaturated carbonic acid, at least one ethylenically unsaturated sulphonic acid, as well as their alkali metal salts and/or ammonium salts, and at least one N-vinylamide,
iii) at least one amide of an ethylenically unsaturated carbonic acid, at least one ethylenically unsaturated sulphonic acid, as well as their alkali metal salts and/or ammonium salts, at least one ethylenically unsaturated carbonic acid and at least one N-vinylamide,
iv) at least one amide of an ethylenically unsaturated carbonic acid, at least one ethylenically unsaturated sulphonic acid, as well as their alkali metal salts and/or ammonium salts, at least one ethylenically unsaturated carbonic acid and at least one N-dialkanolamine,
v) at least one amide of an ethylenically unsaturated carbonic acid, at least one ethylenically unsaturated sulphonic acid, as well as their alkali metal salts and/or ammonium salts, and at least one ethylenically unsaturated carbonic acid, and which is particularly preferably a copolymer which consists of structural units which are derived from:
   acrylamide and/or methacrylamide and 2-acrylamido-2-methylpropane-sulphonic acid (AMPS) and/or vinylsulphonic acid; or from
   acrylamide and/or methacrylamide, and AMPS and/or vinylsulphonic acid and N-vinylformamide and/or N-vinylpyrrolidone; or from
   acrylamide and/or methacrylamide and AMPS and/or vinylsulphonic acid and acrylic acid and/or methacrylic acid; or from
   acrylamide and/or methacrylamide and AMPS and/or vinylsulphonic acid and acrylic acid and/or methacrylic acid and N-vinylformamide and/or N-vinylpyrrolidone.

The copolymers used in accordance with the invention are characterized by the fact that under the influence of multivalent metal ions, even in low concentrations, they do not or essentially do not agglomerate, i.e. they do not cross-link or precipitate. This means that the viscosity of an electrolyte-containing polymer solution of the invention under conditions of use, when multivalent metal ions are almost always present, does not change or only changes slightly, and the filterability of such a polymer solution is maintained.

The fraction of structural units derived from an amide of an ethylenically unsaturated carbonic acid in the copolymer used in accordance with the invention is usually 5% to 90% by weight, in particular 10% to 50% by weight with respect to the total quantity of monomers used in copolymerisation.

The fraction of structural units derived from an ethylenically unsaturated sulphonic acid in the copolymer used in accordance with the invention is usually 10% to 95% by weight, in particular 50% to 90% by weight, with respect to the total quantity of the monomers used for copolymerisation, wherein ethylenically unsaturated sulphonic acids which also contain a carbonamide group in addition to this functional group, are only considered to be in the group formed by the ethylenically unsaturated sulphonic acids.

Particularly preferably, the sum of the fractions given above of structural units derived from an amide of an ethylenically unsaturated carbonic acid and the fractions given above derived from an ethylenically unsaturated sulphonic acid and their alkali metal and/or ammonium salts is a total of 100% by weight of the copolymers used in accordance with the invention.

The fraction of structural units derived from other co-monomers, i.e. from other co-monomers other than an amide of an ethylenically unsaturated carbonic acid and an ethylenically unsaturated sulphonic acid, in the copolymer used in accordance with the invention is not usually more than 20% by weight, in particular no more than 15% by weight with respect to the total quantity of monomers used for the copolymerisation.

Particularly preferably, the sum of the fractions given above of structural units derived from an amide of an ethylenically unsaturated carbonic acid, the fractions given above derived from an ethylenically unsaturated sulphonic acid and their alkali metal and/or ammonium salts and the fractions given above of structural units derived from other co-monomers, i.e. from co-monomers other than an amide of an ethylenically unsaturated carbonic acid and an ethylenically unsaturated sulphonic acid, is a total of 100% by weight of the copolymers used in accordance with the invention.

If the other co-monomers with multivalent metal ions contain cross-linkable groups such as carbonic acid groups, then the fraction of these structural units derived from these co-monomers in the copolymer used in accordance with the invention is not more than 1% by weight, preferably no more than 0.1% by weight, with respect to the total quantity of the monomers used in the copolymerisation. Particularly preferably, these structural units are not present at all in the copolymer used in accordance with the invention.

The copolymers used in accordance with the invention may be produced by means of various types of radical polymerisation, such as solution polymerisation, gel polymerisation or, in particular, inverse emulsion polymerisation. Inverse emulsion polymerisation has the advantage that very high molecular weights can be obtained. In addition, the presence of the polymer in an inverse emulsion means that very rapid hydration and thus a rapid increase in viscosity is possible when the polymer is added to water. In accordance with the invention, the polymer used is thus particularly preferably produced by means of inverse emulsion polymerisation.

As a rule, the polymerisable monomers can be used in their normal commercial form, i.e. without prior purification.

The copolymerisates used in accordance with the invention are produced by copolymerisation using a polymerisation process which is known per se, for example by gel polymerisation, solution polymerisation, but in particular by inverse emulsion polymerization, such that the monomers to be polymerised undergo a radical copolymerisation.

The term “radical copolymerisation” as used in the context of this description should be understood to mean that at least two monomers which can be radical polymerized together under radical copolymerisation conditions can be reacted together. In this manner, copolymerisates with a random or alternating distribution of the structural units derived from at least two monomers can be formed, or indeed block copolymers in which blocks formed by the individual monomers are present, the blocks being covalently bonded together.

The inverse emulsion polymerisation process is known per se. The monomers to be copolymerised are appropriately dissolved in water in succession. If necessary, solid monomers can also initially be dissolved in liquid monomers and the solution obtained thereby can then be dissolved in water. Water-insoluble monomers or monomers which are difficult to dissolve in water are generally dissolved in the hydrophobic liquid prior to adding to the aqueous solution.

In the preferred inverse emulsion polymerisation method, a hydrophilic phase is emulsified which as a rule consists of 10% to 100% by weight of monomers and 0 to 90% by weight of water (with respect to the total mass of the hydrophilic phase) in an inert hydrophobic liquid and is copolymerised therein in the presence of a lipophilic emulsifying agent, preferably an emulsifying agent with an HLB of 10 or less, normally at temperatures of −20° C. to 200° C., preferably 10° C. to 90° C.

Polymerisation normally takes place under atmospheric pressure, but higher pressures can be used. This is particularly to be recommended if the boiling point of the mixture is almost reached or exceeded at atmospheric pressure.

The term “water-soluble” as used in the context of this description means that the solubility is at least 1 g of a substance in 1 litre of water at 25° C.

Copolymerisation is initiated in a manner which is known per se, for example by UV light or high-energy radiation, but usually by means of an initiator delivering radicals which are soluble in the reaction mixture. Examples of suitable initiators are benzoyl peroxide, tert-butyl hydroperoxide, cymene peroxide, methylethylketone peroxide, lauroyl peroxide, tert-butyl perbenzoate, tert-butyl diperphthalate, azodiisobutyronitrile, 2,2′-azo-bis-(2,4-dimethylvaleronitrile), 2-phenyl-azo-2,4-dimethyl-4-methoxyvaleronitrile, 2-cyano-2-propyl-azoformamide, azodiisobutyramide, and dimethyl-, diethyl- or dibutyl-azobis-methylvalerate. Approximately 0.01% to 2% by weight, preferably 0.1% to 1% by weight, of initiator is used with respect to the total quantity of monomer.

The radical initiator or the mixture of different radical initiators may be added to the water and/or the crude petroleum phase.

Any inert liquid which is not soluble in water may be used as the hydrophobic liquid forming the crude petroleum phase. Examples of such liquids are organic solvents, in particular hydrocarbons, examples of which are cyclohexane, n-pentane, n-hexane, n-heptane, i-octane, technical hydrocarbon blends, toluene, xylene, and halogenated hydrocarbons such as chlorobenzene or o-dichlorobenzene. Mixtures of various organic solvents are also suitable.

The lipophilic emulsifying agent has to be soluble in the hydrophobic liquid used and prevents coagulation of the finely divided disperse aqueous phase. Examples of suitable emulsifying agents are organic substances with low HLBs, such as sorbitan esters, for example sorbitan oleate or sorbitan stearate, or ethoxylated fatty acid amides, glycerine fatty acid esters such as glycerine oleate, or diacetyl tartaric esters of fatty acid glycerides, polysiloxanes, or polyalkylene glycols, or a mixture of a lipophilic and a hydrophilic emulsifying agent with a total HLB of <10.

The HLB (hydrophilic-lipophilic balance) describes the hydrophilic and lipophilic fraction of non-ionic surfactants.

For the purposes of this description, the HLB calculated using the Griffin method is used. This is calculated using the following formula:

HLB=20*(1−Mₗ/M)

where Mₗ denotes the molar mass of the lipophilic fraction of the surfactant molecule and M is the molar mass of the whole molecule. The factor 20 is an arbitrary scaling factor. This therefore provides a scale of 1 to 20. A HLB of 1 denotes a lipophilic compound; a chemical compound with a HLB of 20 has a high hydrophilic fraction.

As a rule, the lipophilic emulsifying agent or a mixture of various lipophilic emulsifying agents are present in quantities of 0.05% to 10% by weight, preferably 0.1% to 5% by weight with respect to the total mass of the batch. The volume of the aqueous solution and the hydrophobic liquid is normally in the ratio 0.5-10:1. Dispersion of the aqueous solution in the crude petroleum phase with the added lipophilic protective colloid/lipophilic emulsifying agent is carried out in a manner which is known per se, preferably by vigorous stirring. The copolymerisation is appropriately carried out in the absence of oxygen. This can be carried out in known manner by flushing or passage of an inert gas such as nitrogen. As a rule, copolymerisation is complete after 0.3 to 3 h. When copolymerisation is complete, the copolymerisate is obtained as a dispersion in a water-in-oil phase.

The prepared water-in-oil dispersion generally consists of 20% to 90% by weight of an aqueous phase with respect to the total mass of the batch. The aqueous phase contains practically all of the copolymerisate. The concentration of the copolymerisates in the aqueous phase is usually 20% to 60% by weight with respect to the total mass of the aqueous phase. The continuous external phase of the water-in-oil polymer dispersion, namely the liquid hydrocarbon and the water-in-oil emulsifying agents, is as a rule in an amount of the entire dispersion of 10% to 80% by weight with respect to the total weight of the batch.

For use in the tertiary recovery of crude petroleum, the polymers must be released from the micelles of the water-in-oil dispersion. This is carried out by destroying the micelles after the dispersion has been added to water or a saline solution, either by introducing sufficient mechanical energy (for example by stirring) or by adding a surfactant with a HLB of >10. This procedure is known as inverting. Suitable surfactants produce a complete inversion which occurs within a few seconds without the formation of agglomerates. The inverting surfactant can also be added directly to the inverse copolymer emulsion.

Preferably, a surfactant is used which, in accordance with the present invention, improves the filterability of the polymer solution. The invention describes that non-ionic surfactants, in particular surfactants consisting of fatty alcohols, fatty acids and alkylphenols with eight to ten ethylene oxide units, are suitable for carrying out a rapid, complete inversion in saline solutions even at high salt concentrations, and of improving the filterability of the copolymer solution.

The copolymerisation can also be carried out in accordance with the method using what is known as gel polymerisation. To this end, solutions of typically 5% to 60% by weight with respect to the total mass of the solvent (mixture) of the co-monomers in water or a solvent mixture of water and a solvent which is completely miscible with water such as an alcohol, for example, is copolymerised with known suitable catalyst systems without mechanical mixing, utilising the Tromsdorff-Norrisch effect (Rios Final Rep. 363, 22; 35 Makromol. Chem. 1, 169 (1947)). Gel polymerisation too is preferably carried out in the absence of oxygen, for example in a protective gas atmosphere such as nitrogen, for example at temperatures or −20° C. to 200° C., preferably 10° C. to 90° C., and initiated in a manner which is known (see the discussion regarding inverse emulsion polymerisation), wherein if necessary, the catalyst systems can be used in combination with reducing agents such as sodium hydrogen sulphite, or redox systems which contain a sulphinic acid as the reducing component, for example.

The copolymerisates to be used in accordance with the invention formed in this manner in the form of aqueous gelled solids can be mechanically comminuted and dried and thus can be kept in the solid form. Preferably, however, the aqueous gelled solids are used.

For use in the tertiary recovery of crude petroleum, the gel polymerisates are diluted with water or electrolyte solution. In this manner, care should be taken that in particular, the copolymer powder is completely dissolved, which can take a long time on occasion, so that a homogeneous, agglomerate-free copolymer solution is obtained.

Starting from coagulate-free dispersions which are stable to sedimentation, which can be rapidly inverted and result in homogeneous copolymer solutions without agglomerates, is of great technical advantage.

Thus, polymer solutions wherein the synthetic copolymer is produced by inverse emulsion polymerisation are particularly preferred.

The average molecular weight of the copolymers used in the invention can vary widely. They can be determined by means of gel permeation chromatography (GPC). The standards used are commercially available polymers, for example of acrylamide with molecular weights of 1140000 dalton and 5550000 dalton. The separation medium may be a column consisting of a polyhydroxymethacrylate copolymer matrix with a pore diameter of 30000 Å. Typically, the mass average molecular weights of the copolymers used in accordance with the invention are in the range 10000 to 25000000 dalton (g/mol), preferably in the range 1000000 to 10000000 dalton.

Particularly preferably, polymer solutions are used which contain copolymers with a mass average molecular weight of at least 1 million dalton.

The non-ionic surfactant used in the polymer solution of the invention is a selected alkoxylated compound. Non-ionic surfactants which have a HLB of at least 10 are preferred. The preferred embodiments discussed below of the non-ionic surfactants used in accordance with the invention are all compounds of this type which have a HLB of at least 10.

In general, the alkoxy groups are groups containing two to four carbon atoms. These are groups with the formula —(CₙH₂ₙ—O)ₘ—, wherein n is an integer in the range 2 to 4 and m is an integer which is typically in the range 1 to 10. Different alkoxy groups may also be present in one surfactant, for example ethoxy and propyloxy groups. They may be randomly distributed or in the form of blocks.

The non-ionic surfactants used in accordance with the invention—depending on the type of manufacture—are mixtures of surfactants with different degrees of alkoxylation. These surfactants are characterized by providing a mean degree of alkoxylation. The mean degree of alkoxylation is often given in the data sheets from the manufacturer of the surfactants. The surfactant mixture can be separated using chromatographic methods. This also brings about a separation as a function of the degree of alkoxylation of the surfactants. A mean can be constructed from the percentages by weight of the individual components. In accordance with the invention, the mean degree of alkoxylation of these non-ionic surfactants is between 8 and 10.

Polymer solutions wherein the alkoxyl groups of the non-ionic surfactant are ethoxy groups are particularly preferred.

The non-ionic surfactants used in accordance with the invention are derived from fatty alcohols or from alkylphenols which are each alkoxylated and have a selected degree of alkoxylation.

Preferred non-ionic surfactants are derived from C₈-C₁₈ fatty alcohols, in particular from C₁₀-C₁₅ fatty alcohols or from C₁-C₁₂ alkylphenols, each being alkoxylated and having a selected degree of alkoxylation.

Non-ionic surfactants which are derived from a C₁₀-C₁₅ alcohol and with a mean of 8-10 ethylene oxide units are particularly preferred, and non-ionic surfactants which are derived from a C₁₃ alcohol and with a mean of 8 ethylene oxide units are most particularly preferred.

As a rule, the electrolyte-containing polymer solution of the invention has a concentration of water-soluble copolymers of 0.01% to 2% by weight, preferably 0.01% to 0.5% by weight and particularly preferably 0.05% to 0.5% by weight, wherein the concentration details are each with respect to the total quantity of the polymer solution.

As a rule, the electrolyte-containing polymer solution of the invention has a concentration of non-ionic surfactant of 0.01% to 5% by weight, preferably 0.01% to 1% by weight and particularly preferably 0.05% to 0.5% by weight, wherein the concentration details are each with respect to the total quantity of the polymer solution.

The polymer solution of the invention is characterized by very good filtration behaviour. This means that the polymer solution does not cause any significant blockages in sedimentary rock. For the purposes of this description, the filtration behaviour is characterized as follows:

Quartz sand (P-sand 0.04-0.15 from Busch Quarz GmbH) is used. A 25 cm long tube with an internal cross sectional area of 0.694 cm² is completely filled with sand. The sand is packed down. The flooding medium used is demineralised water with the following added salts, with respect to the total mass of water: 18.7% by weight NaCl, 0.15% by weight KCl, 0.2% by weight MgCl₂ and 1.0% by weight CaCl₂. The salt water is filtered prior to injection into the packed sand through a BECO S100 type depth filter with a nominal retention rate of 0.1 μm. Next, the given quantities of polymer and surfactant are added to the water. Initially, pure salt water is pumped through the packed sand for a period of 10 to 20 min using a HPLC pump at a set flow rate of 5 ml/min. This is then switched to the flooding medium with the polymer and surfactant and again the packed sand is flushed at a flow rate of 5 ml/min for at least 60 min. It is then switched back to pure salt water. Depending on the flooding medium used, different pressures are obtained which can be recorded using data loggers.

Particularly preferred polymer solutions are characterized by the filtration behaviour as determined by the above method, wherein:
the pressure should only exhibit a slight increase during the test period, which increase is less than 5% of the initial value for injection of the polymer solution (ΔP_{inject}). Ideally, the pressure is constant throughout the test period. The variations in pressure of the measured values should be less than ±0.7 bar. At constant pressure, no deposits or blockages are formed by the polymer in the packed sand;
furthermore, when injection of the polymer solution is complete, the pressure should drop to a value which differs from the value prior to beginning injection by less than ±20% (Δp_{flush}). A value of more than 20% indicates that there are deposits of polymer in the packed sand.

With long injection periods and long distances which the polymer has to cover in an crude petroleum reservoir, even small deposits can result in severe blockages in the formation.

The absolute pressure obtained upon measurement is determined by the concentration of the polymer in the solution, the interactions with the surfactant and the sand as well as the molecular weight of the polymer and its linearity and/or cross-linking. The higher the molecular weight, the higher the viscosity. For equal polymer concentrations, then, higher molecular weights mean higher viscosities and thus higher pressures. Because of the shear sensitivity, however, no clear relationships can be derived between the molecular weight/viscosity and pressure in the packed sand.

Cross-linked or branched polymers can produce comparable pressures to linear polymers, but the pressure is observed to rise during the test along with a higher pressure upon passage through the packed sand with the salt solution.

The electrolyte-containing polymer solutions of the invention are primarily used for the tertiary recovery of crude petroleum.

Thus, the invention also concerns a method for tertiary recovery of crude petroleum by flooding, wherein the electrolyte-containing aqueous polymer solution described above is used as a flooding medium.

A preferred method is characterized in that in order to manufacture the electrolyte-containing aqueous polymer solution, initially a concentrated aqueous solution of the copolymer is produced with water or electrolyte solution, either by inverting the water-in-oil copolymer dispersion or by dissolving or diluting the copolymers from gel polymerisation. This solution is then diluted further to the target concentration with the electrolyte-containing salt solution or, if appropriate, with the addition of the non-ionic surfactant.

A method in which the water used to dilute the concentrated polymer solution or the water-in-oil emulsion for admixing with the flooding medium is reservoir water is very particularly preferred. This is of particular advantage, since fresh water is frequently not available at all, or not available in sufficient quantities, especially in offshore locations.

The added non-ionic surfactant primarily has two functions. Firstly, it releases the polymer from the water-in-oil emulsion and secondly, it improves the injectivity of the corresponding polymer solution into the crude petroleum reservoirs. Only surfactants which are completely soluble and do not flocculate in salty water, for example the preferred reservoir water, are suitable. Surfactants of the type cited above are used, in particular surfactants of the isotridecanol type with at least seven ethylene oxide units.

The following examples illustrate the invention without limiting it.

### EXAMPLES 1 TO 4

### Inverse Emulsion Polymerisation

### EXAMPLE 1

20 g of sorbitan monooleate was dissolved in 160 g of C₁₁-C₁₆-isoparaffin. 110 g of water and 36 g of aqueous ammoniacal solution (25%) were placed in a beaker, cooled to 5° C., and 110 g of 2-acrylamido-2-methylpropanesulphonic acid was added. The pH was adjusted to 7.1 using the ammoniacal solution (25%). Next, 146.66 g of acrylamide (50% solution in water) was added.

The aqueous monomer solution was added to the solution of C₁₁-C₁₆ isoparaffin and sorbitan monooleate with vigorous stirring. It was inerted for 45 min with nitrogen. To initiate, 0.5 g of azoisobutyronitrile was dissolved in 12 g of C₁₁-C₁₆-isoparaffin and added to the reaction mixture, and the solution was heated to 50° C. As soon as the maximum temperature was reached, it was heated for 2 h with the aid of a crude petroleum bath to 80° C. The suspension was cooled to ambient temperature and could then be used without further working up.

### EXAMPLE 2

Production was as described for Example 1, but with the following monomer composition:

110 g of 2-acrylamido-2-methylpropanesulphonic acid, 55 g of acrylamide, 18.3 g of N-vinylpyrrolidone.

### EXAMPLE 3

Production was as described for Example 1, but with the following monomer composition:

45 g of 2-acrylamido-2-methylpropanesulphonic acid, 82.5 g of acrylamide.

### EXAMPLE 4 (COMPARATIVE)

Production was as described for Example 1, but with the following monomer composition:

98 g of acrylamide, 42 g of acrylic acid.

### EXAMPLE 5

### Behaviour of Surfactants in Salt Water

The solubility of surfactants with a HLB 10 was investigated in salt water with 20.0% by weight NaCl, 0.7% by weight KCl, 0.35% by weight MgCl₂ and 2.0% by weight CaCl₂ (with respect to the total weight of solution). In each case, a 2% by weight surfactant solution was used, with respect to the total weight of the solution. Only surfactants which dissolved in a homogeneous manner in salt water are also suitable for application in tertiary crude petroleum recovery.

The results are set out in the following table:

| | Homogeneously |
|---|---|
| Surfactant | soluble? |
| Sorbitan monolaurate 4 EO | no |
| Sorbitan monostearate 20 EO | no |
| Sorbitan monooleate 5 EO | no |
| Dodecylalcohol 4 EO | no |
| Sodium dodecylsulphate | no |
| Coconut fatty amine 2 EO | no |
| Sorbeth-30-Tetraoleate | no |
| Sorbitan trioleate 20 EO | no |
| Sorbitan tristearate 20 EO | no |
| Isotridecanol 6 EO | no |
| Isotridecanol 7 EO | yes |
| Isotridecanol 8 EO | yes |
| Isotridecanol 9 EO | yes |
| Isotridecanol 10 EO | yes |
| Oleylalcohol 10 EO | yes |
| Dodecylalcohol 7 EO | yes |
| Nonylphenol 10 EO | yes |

### EXAMPLE 6

### Viscosities of Polymer/Surfactant Solutions in Salt Water

The viscosities given below were measured in water with the following composition: 18.7% by weight NaCl, 0.15% by weight KCl, 0.2% by weight MgCl₂ and 1.0% by weight CaCl₂ (with respect to the total solution weight).

In each case, a 0.2% by weight polymer solution (with respect to the total solution weight) was used in salt water with the quantities of surfactant shown in the table (% by weight with respect to the total solution weight) and the viscosity was measured using a rheometer at 30° C., and at a shear rate of 10 s⁻¹.

The results are set out in the following table:

| | | Viscosity |
|---|---|---|
| Polymer | Surfactant | [mPas] |
| Example 1 | 0.0% | 7.8 |
| Example 1 | 0.1% isotridecanol 8 EO | 9.2 |
| Example 2 | 0.0% | 7.3 |
| Example 2 | 0.1% isotridecanol 8 EO | 10.6 |
| Example 4 | 0.0% | 6.8 |
| (comparative) | | |
| Example 4 | 0.1% isotridecanol 8 EO | 8.0 |
| (comparative) | | |

### EXAMPLES 7-12

The viscosities given below were measured in water with the following composition: 18.7% by weight NaCl, 0.15% by weight KCl, 0.2% by weight MgCl₂ and 1.0% by weight CaCl₂, each with respect to the total solution weight.

In each case, a 0.75% by weight polymer solution (with respect to the total solution weight) with the polymer of Example 1 was added to the salt water defined above and the quantity of surfactant added which produced a 0.40% by weight surfactant solution (with respect to the total solution weight). The viscosity was measured using a rheometer at 80° C., and at a shear rate of 10 s⁻¹.

The results are set out in the following table:

| | | Viscosity |
|---|---|---|
| Example | Surfactant | [mPas] |
| 7 | Isotridecanol 6 EO | Not measurable |
| (comparative) | | as flocculated |
| 8 | Isotridecanol 7 EO | Not measurable |
| (comparative) | | as flocculated |
| 9 | Isotridecanol 8 EO | 93.7 |
| 10 | Isotridecanol 9 EO | 104.6 |
| 11 | Isotridecanol 10 EO | 140.2 |
| 12 | Nonylphenol 10 EO | 151.5 |

### EXAMPLES 13-14

The viscosities given below were measured in water with the following composition: 13.0% by weight NaCl, 1.0% by weight CaCl₂, each with respect to the total solution weight. In each case, a 0.50% by weight polymer solution (with respect to the total solution weight) was used with the polymer in the salt water defined above and the quantity of surfactant added which produced a 0.50% by weight surfactant solution (with respect to the total solution weight). The viscosity was measured using a rheometer at different temperatures and at a shear rate of 7 s⁻¹.

The results are set out in the following table:

| | | Temperature | Viscosity |
|---|---|---|---|
| Example | Polymer | [° C.] | [mPas] |
| 13 | Polymer of Example 4 | 30 | 9.4 |
| (comparative) | | | |
| 13 | Polymer of Example 4 | 60 | 20.3 |
| (comparative) | | | |
| 13 | Polymer of Example 4 | 80 | 19.2 |
| (comparative) | | | (flocculated) |
| 14 | Polymer of Example 3 | 30 | 92.1 |
| 14 | Polymer of Example 3 | 60 | 171.8 |
| 14 | Polymer of Example 3 | 80 | 127.2 |

### EXAMPLES 15-18

### Infectivity into Packed Sand

P-Sand 0.04-0.15 from Busch Quarz GmbH was used. A 25 cm long tube with an internal cross sectional area of 0.694 cm² was completely filled with sand. The sand was packed down. The flooding medium was demineralised water with the following added salts: 18.7% by weight NaCl, 0.15% by weight KCl, 0.2% by weight MgCl₂ and 1.0% by weight CaCl₂ (with respect to the total solution weight). Prior to injection into the packed sand, the salt water was filtered through a BECO S100 type depth filter with a nominal retention rate of 0.1 μm. Next, the given quantities of polymer and surfactant were added to the water (each time with respect to the total solution weight). Initially, pure salt water was pumped through the packed sand for a period of 10 to 20 min using a HPLC pump at a set flow rate of 5 ml/min. It was then switched over to the flooding medium with the polymer and surfactant and again, the packed sand was flushed at a flow rate of 5 ml/min for at least 40 min. It was then switched back to pure salt water. Depending on the respective flooding medium, different pressures were obtained which were recorded using a data logger.

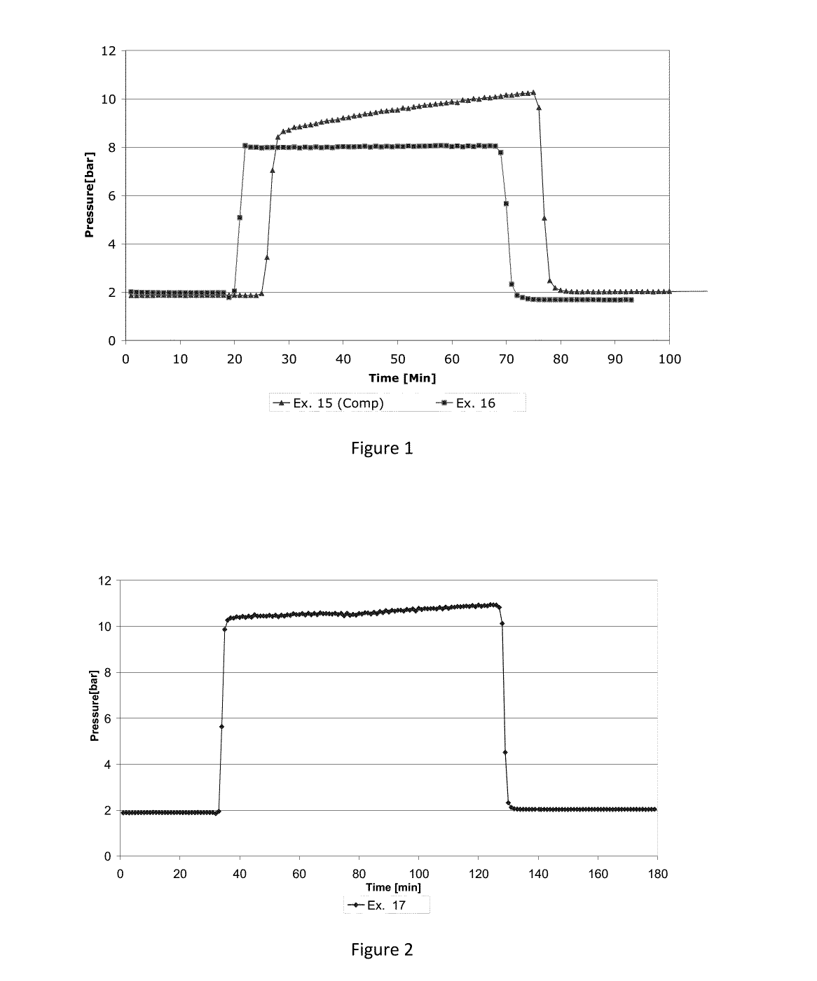

Example 15 (comparative) concerns the filtration of 0.2% by weight polymer from Example 1 without surfactant. The results are shown in FIG. 1.

Example 16 concerns the filtration of 0.2% by weight of polymer from Example 1 with 0.1% by weight of the ethoxylated surfactant isotridecanol 8EO (EO=ethylene oxide units). The results are also shown in FIG. 1.

Example 17 concerns the filtration of 0.3% by weight of polymer from Example 3 with 0.1% by weight of the ethoxylated surfactant isotridecanol 8EO. The results are shown in FIG. 2.

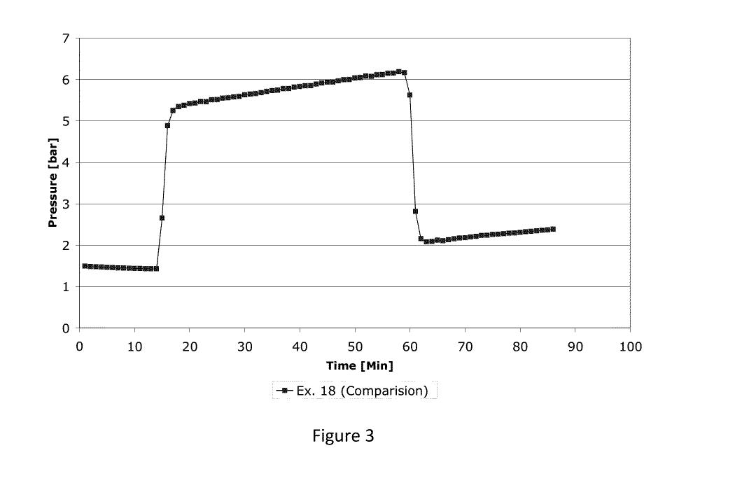

Example 18 (comparative) concerns the filtration of 0.2% by weight of polymer from Example 4 with 0.1% by weight of the ethoxylated surfactant isotridecanol 8EO. The results are shown in FIG. 3.

1. (canceled)

2-22. (canceled)

23. An aqueous polymer solution, comprising:
5% to 35% by weight with respect to the total weight of the aqueous polymer solution of an alkali metal or ammonium salt of at least one dissolved synthetic copolymer containing structural units of
(i) at least one amide of an ethylenically unsaturated carbonic acid; and
(ii) at least one of ethylenically unsaturated sulphonic acid,
wherein said aqueous polymer solution further contains at least one non-ionic surfactant selected from the group consisting of alkoxylated fatty alcohols, alkoxylated alkylphenols and alkoxylated fatty acids, wherein a mean degree of alkoxylation of said non-ionic surfactant is 8-10.

24. The polymer solution of claim 23,
wherein the amount of said dissolved synthetic copolymer is 10% to 35% by weight, with respect to the total quantity of the polymer solution; and
wherein said polymer solution further contains at least one of alkali metal salts and alkaline-earth metal salts.

25. The polymer solution of claim 24, wherein the quantity of synthetic copolymer salts formed by alkaline-earth metal ions, is at least 0.01% by weight, with respect to the total weight of the polymer solution.

26. The polymer solution of claim 23, wherein said amide of ethylenically unsaturated carbonic acid is selected from the group consisting of acrylamide, methacrylamide, their N—C₁-C₄ alkyl derivatives and their N-methyloyl derivatives.

27. The polymer solution of claim 23, wherein said ethylenically unsaturated sulphonic acid is selected from the group consisting of vinylsulphonic acid, 2-acrylamido-2-methylpropanesulphonic acid, 2-methacrylamido-2-methylpropanesulphonic acid, styrenesulphonic acid, their alkali metal salts and ammonium salts.

28. The polymer solution of claim 23, wherein said synthetic copolymer additionally contains structural units of at least one ethylenically unsaturated carbonic acid and an additional copolymerisable monomer selected from the group consisting of alkyl esters of ethylenically unsaturated carbonic acids, oxyalkyl esters of ethylenically unsaturated carbonic acids, esters of ethylenically unsaturated carbonic acids with N-dialkylalkanolamines and N-vinylamides.

29. The polymer solution of claim 28, wherein said ethylenically unsaturated carbonic acid is selected from the group consisting of acrylic acid, methacrylic acid, fumaric acid, maleic acid, itaconic acid and crotonic acid.

30. The polymer solution of claim 28,
wherein said alkyl ester of ethylenically unsaturated carbonic acids is an alkyl ester of acrylic acid, methacrylic acid, fumaric acid, maleic acid, itaconic acid or crotonic acid;
wherein said oxyalkyl ester of ethylenically unsaturated carbonic acids is a 2-hydroxyethyl ester of acrylic acid, methacrylic acid, fumaric acid, maleic acid, itaconic acid or crotonic acid;
wherein said ester of ethylenically unsaturated carbonic acids with N-dialkylalkanolamines is N,N-dimethylethanolamine methacrylate, its salt or quaternary products; and
wherein said N-vinylamide is N-vinylformamide, N-vinyl acetamide, N-vinyl-N-methylacetamide or cyclic N-vinylamide compounds.

31. The polymer solution of claim 23, wherein said synthetic copolymer consists of structural units of:
at least one amide of an ethylenically unsaturated carbonic acid and at least one ethylenically unsaturated sulphonic acid, as well as their alkali metal salts and ammonium salts;
at least one amide of an ethylenically unsaturated carbonic acid, at least one ethylenically unsaturated sulphonic acid, as well as their alkali metal salts and ammonium salts, and at least one N-vinylamide;
at least one amide of an ethylenically unsaturated carbonic acid, at least one ethylenically unsaturated sulphonic acid, as well as their alkali metal salts and ammonium salts, at least one ethylenically unsaturated carbonic acid and at least one N-vinylamide;
at least one amide of an ethylenically unsaturated carbonic acid, at least one ethylenically unsaturated sulphonic acid, as well as their alkali metal salts and ammonium salts, at least one ethylenically unsaturated carbonic acid and at least one N-dialkanolamine; or
at least one amide of an ethylenically unsaturated carbonic acid, at least one ethylenically unsaturated sulphonic acid, as well as their alkali metal salts and ammonium salts, and at least one ethylenically unsaturated carbonic acid, consisting of structural units of:
at least one of acrylamide and methacrylamide and 2-acrylamido-2 methylpropane-sulphonic acid (AMPS) and vinylsulphonic acid;
at least one of acrylamide and methacrylamide, and AMPS and vinylsulphonic acid and N-vinylformamide and N-vinylpyrrolidone;
at least one of acrylamide and methacrylamide and AMPS and vinylsulphonic acid and acrylic acid and methacrylic acid; or
at least one of acrylamide and methacrylamide and AMPS and vinylsulphonic acid and acrylic acid and methacrylic acid and N-vinylformamide and N-vinylpyrrolidone.

32. The polymer solution of claim 23, wherein said synthetic copolymer is produced by inverse emulsion polymerisation.

33. The polymer solution of claim 23, wherein said copolymer has a mass average molecular weight of at least 1 million Dalton.

34. The polymer solution of claim 23, characterized in that the non-ionic surfactant has an HLB of at least 10.

35. The polymer solution of claim 34, wherein the alkoxy groups of said non-ionic surfactant are ethoxy groups.

36. The polymer solution of claim 35, wherein the non-ionic surfactant is a C₁₀-C₁₅ alcohol with a mean of 8-10 ethylene oxide units.

37. The polymer solution of claim 23, wherein said synthetic copolymer is used in a concentration of 0.01% to 1% by weight, respectively with respect to the total quantity of said polymer solution.

38. The polymer solution of claim 23, wherein said non-ionic surfactant is used in a concentration of 0.01% to 1% by weight, with respect to the total quantity of said polymer solution.

39. The polymer solution of claim 23,
wherein said polymer solution exhibits filtration at 5 ml/min through 25 cm long packed sand with a cross-sectional area of 0.694 cm²,
wherein during injection of the polymer/surfactant/salt water, the pressure increase within 60 minutes is less than 5% of the initial value for injection of the polymer solution (ΔP_{inject}), the variations in pressure of the values measured are less than ±0.7 bar, and the pressure when injection of said polymer solution is complete drops to a value which differs from the value prior to beginning injection by less than ±20% (Δp_{flush}).

40. A method for tertiary recovery of crude petroleum comprising:
flooding a crude petroleum reservoir with an aqueous polymer solution containing:
5% to 35% by weight with respect to the total weight of the aqueous polymer solution of an alkali metal or ammonium salt of at least one dissolved synthetic copolymer containing structural units of
(i) at least one amide of an ethylenically unsaturated carbonic acid; and
(ii) at least one of ethylenically unsaturated sulphonic acid,
at least one non-ionic surfactant selected from the group consisting of alkoxylated fatty alcohols, alkoxylated alkylphenols and alkoxylated fatty acids, wherein the mean degree of alkoxylation of said non-ionic surfactant is 8-10.

41. A method of making an aqueous polymer solution comprising:
making a first aqueous solution of a synthetic copolymer with water or an electrolyte solution by inverting a water-in-oil copolymer dispersion or by dissolving said copolymer from gel polymerisation;
diluting said concentrated aqueous solution with an electrolyte-containing solution, or water;
wherein said polymer solution contains:
5% to 35% by weight with respect to the total weight of said aqueous polymer solution of an alkali metal or ammonium salt of at least one dissolved synthetic copolymer containing structural units of
(i) at least one amide of an ethylenically unsaturated carbonic acid; and
(ii) at least one of ethylenically unsaturated sulphonic acid,
at least one non-ionic surfactant selected from the group consisting of alkoxylated fatty alcohols, alkoxylated alkylphenols and alkoxylated fatty acids, wherein the mean degree of alkoxylation of said non-ionic surfactant is 8-10.

42. The method of claim 40, wherein said electrolyte solution is reservoir water.
